(19) United States
(12) Patent Application Publication
(10) Pub. No.: US 2008/0173517 A1
(43) Pub. Date: Jul. 24, 2008

(54) FRICTION PLATE FOR WET MULTI-PLATE CLUTCH

(75) Inventors: Tsuyoshi HIRAYANAGI, Fukuroi-shi (JP); Hideaki SUZUKI, Fukuroi-shi (JP)

Correspondence Address: SUGHRUE-265550, 2100 PENNSYLVANIA AVE. NW, WASHINGTON, DC, 20037-3213, US

(73) Assignee: NSK-WARNER KABUSHIKI KAISHA, Tokyo (JP)

(21) Appl. No.: 12/015,835

(22) Filed: Jan. 17, 2008

(30) Foreign Application Priority Data
Jan. 19, 2007 (JP) 2007-009790

(51) Int. Cl. F16D 69/00

(52) U.S. Cl. 192/210

(57) ABSTRACT

Segment pieces 42 of a friction material are bonded onto a core plate 41 of a friction plate 40 for a wet multi-plate clutch at intervals. A porosity of a perimetric portion 43 of the segment piece 42 which is shaded with oblique lines is made smaller by pressing or increasing a resin content of the perimetric portion 43. In addition, a perimetric portion which corresponds to the portion 43 may be made up of a separate member of a different material having a small porosity.

### BACKGROUND OF THE INVENTION

1. Field of the Invention

The present invention relates to a friction plate for a wet multi-plate clutch used in a clutch and a brake of an automatic transmission.

2. Description of Related Art

FIG. 1 shows a basic configuration of a wet multi-plate clutch 10, and in the figure, reference numeral 21 denotes a clutch casing, 22 a hub to which rotation is transmitted, 23 a spline groove formed on the clutch casing, 24 a spline groove formed on the hub, 25 a piston for pushing separator plates 30 and friction plates 40 against a backing plate 26, 27 a snap ring which supports the backing plate 26, and 28 a seal ring for the piston ring 25.

In recent years, the demand for further improvement in fuel economy of motor vehicles has still been increasing, and as a part of the improvement in fuel economy, there are also increasing demands for further reduction in dragging torque generated between friction plates and separator plates when a clutch is disengaged, effective use of resources and reduction in production costs in automatic transmissions of motor vehicles.

To cope with the demands, it has been considered that segment pieces of a friction material are cut out from a base material so that the segment pieces so cut out are bonded on a core plate at intervals. This increases the yield of the friction material. In addition, oil grooves having a depth equal to the thickness of the friction material are formed between adjacent segment pieces, so that the oil discharging properties of the friction plate can be increased and the dragging torque when the clutch is disengaged can be decreased.

Furthermore, since the cutting out of segment pieces from the base material can also be suitable for facilitation of the production of friction plates of various sizes, the reduction in production costs has been enabled in association with the improvement in the yield of friction material.

However, when compared with conventional friction plates, the friction plate which utilizes the segment pieces has its inherent problems that friction becomes high in an initial stage of engagement of the clutch and that a gear shift shock is generated.

Since the segment piece is cut off at inside-diameter, outside-diameter and both circumferential sides thereof by a press machine, fine holes are opened in their end faces. It has been found out that due to this, oil residing in the friction material and oil existing on the surface thereof is discharged when the clutch is engaged and the retention of oil, which should constitute a cushion on the friction surface when the clutch is engaged, is thus made difficult, resulting in an increase in initial friction coefficient.

### SUMMARY OF THE INVENTION

The invention has been made in view of the above situations and an object thereof is to prevent an engagement shock that is generated in the way described above in an initial stage of engagement of a wet multi-plate clutch.

With a view to solving the problem, according to an aspect of the invention, there is obtained a friction plate for a wet multi-plate clutch including:

a core plate; and

a plurality of segment piece of a friction material bonded onto the core plate at intervals, wherein

a porosity of a perimetric portion of the segment piece which surrounds inside-diameter, outside-diameter and both circumferential sides thereof is made smaller than that of other portions of the segment piece.

According to the invention, the amount of oil discharged from the side portions of the segment piece can be reduced, and oil residing in the friction material and oil existing on the surface portion is not discharged immediately but remains on the friction surface. Thus remaining oil provides a cushioning effect and prevents the increase in friction coefficient in the initial stage of the clutch engagement, thereby making it possible to prevent the occurrence of a grabbing shock in the initial state of engagement of the clutch.

### BRIEF DESCRIPTION OF THE DRAWINGS

FIG. 1 is a sectional view showing a basic configuration of a wet multi-plate clutch;

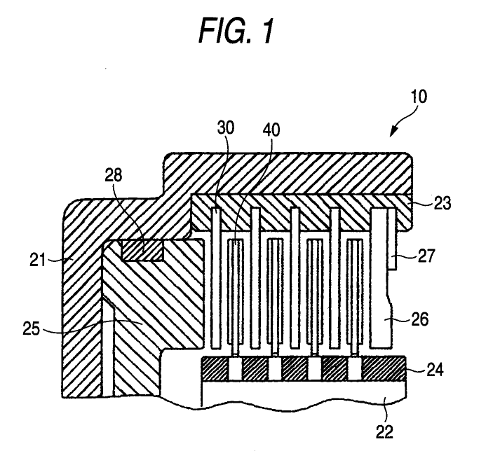

FIG. 2 is a front view showing a first embodiment of the invention;

FIG. 3 is a sectional view taken along the line III-III in FIG. 2;

FIG. 4 is a sectional view, similar to FIG. 3, which shows a second embodiment of the invention; and

FIG. 5 is a diagram showing an advantage of the invention.

### DETAILED DESCRIPTION OF THE PREFERRED EMBODIMENTS

As the method for decreasing the porosity of a perimetric portion of a segment piece of a friction material, there are considered a method for pressing the perimetric portion to increase the density of an interior of the perimetric portion, a method for providing another non-porous material on the perimetric portion or a method for applying a coating of a non-porous material to the perimetric portion.

### Embodiments

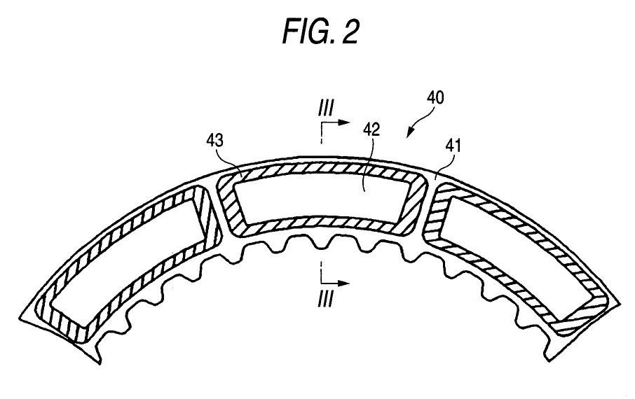

FIG. 2 is a front view of an embodiment of a friction plate 40 of the invention, and segment pieces 42 of a friction material are bonded onto a core plate 41 at equal intervals. In addition, a perimetric portion of the segment piece 42 is pressed so as to decrease the porosity of the perimetric portion so pressed. Due to this, the amount of oil that is discharged from side portions of the segment piece can be decreased, whereby oil residing in an interior of the friction material and oil remaining on a surface portion thereof is made not to be discharged immediately but remains on a friction surface, and the oil so remaining produces a cushioning function, thereby making it possible to prevent the occurrence of a biting in an initial stage of engagement of the clutch. A portion shaded with oblique lines indicated a perimetric portion which is pressed to decrease the porosity.

In order to make appropriate porosity of the perimetric portion, when pressing the perimetric portion of the segment piece 42, thickness of the segment piece 42 after pressing is preferably 20 to 50% of the thickness of that before pressing.

Further, as for kinds of the resin material for coating the perimetric portion of the segment piece 42, phenol based resin or silicone based resin can be exemplified.

Furthermore, as the method for providing another non-porous material on the perimetric portion, it is adaptable to paste a sheet-like material having heat resistance property around the segment piece 42. The sheet-like material may be made of silicone rubber material. In addition, it is also adaptable to surround the periphery of the segment piece 42 by non-porous resin such as phenol based resin, silicone based resin or etc.

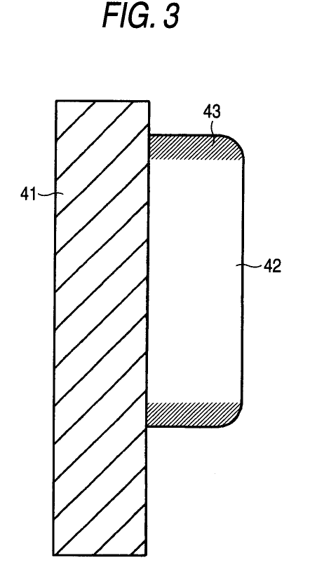

FIG. 3 is a sectional view taken along the line III-III in FIG. 2, and reference numeral 41 denotes the core plate, and 42 the segment piece of a friction material. The portion 43 which is shaded with oblique lines indicates the portion which is pressed to decrease the porosity.

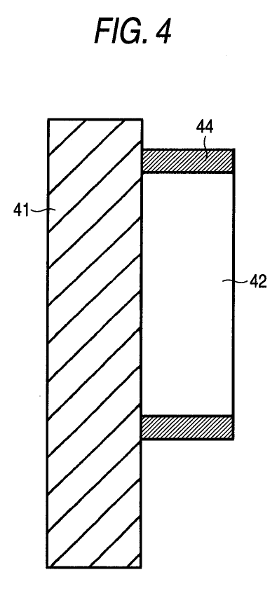

FIG. 4 is a sectional view, similar to FIG. 3, which shows another embodiment of the invention. In this embodiment, a portion of a different material which has a smaller porosity is provided on a perimeter of a segment piece 42 of a friction material which is bonded onto the core plate 41. In this embodiment, the portion of the different material may be formed by coating the different material onto the perimeter of the segment piece 42.

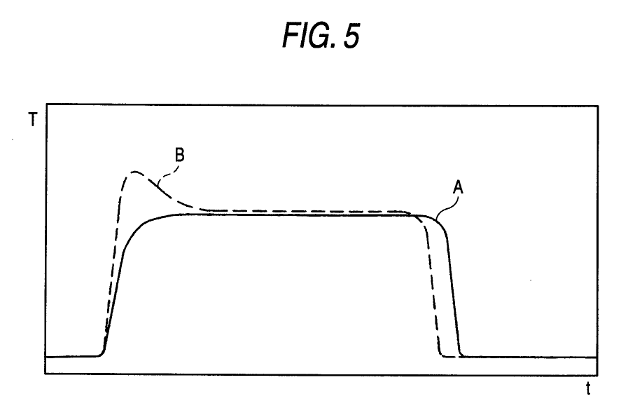

FIG. 5 is a diagram showing the advantage of the invention, in which a transmitting torque is expressed by an axis of ordinates and the elapse of time is expressed by an axis of abscissas. A broken line B is associated with a torque transmission by a conventional clutch and indicates that a high engaging torque is generated in an initial stage of engagement of the clutch. A solid line A is associated with a torque transmission by the clutch incorporating the segment pieces of the invention and indicates that a uniform torque transmission is carried out from the beginning to the end of the engagement of the clutch.

According to the invention, the porosity of the perimetric portion of the segment piece of a friction material can be decreased by the comparatively simple means, thereby making it possible to prevent the occurrence of the high engaging torque in the initial stage of engagement of the clutch.

What is claimed is:

1. A friction plate for a wet multi-plate clutch comprising:
a core plate; and
a plurality of segment piece of a friction material bonded onto the core plate at intervals, wherein
a porosity of a perimetric portion of the segment piece which surrounds inside-diameter, outside-diameter and both circumferential sides thereof is made smaller than that of other portions of the segment piece.

2. The friction plate as set forth in claim 1, wherein
the porosity of the perimetric portion of the segment piece is made small by pressure molding the perimetric portion.

3. The friction plate as set forth in claim 1, wherein
a resin content rate of the perimetric portion of the segment piece is higher than the other portion of the segment piece.

4. The friction plate as set forth in claim 1, wherein
a non-porous member is provided on the perimetric portion of the segment piece.

5. The friction plate as set forth in claim 1, wherein
a coating of a non-porous material is provided on the perimetric portion of the segment piece.
